(19) United States
(12) Patent Application Publication
(10) Pub. No.: US 2004/0210537 A1
(43) Pub. Date: Oct. 21, 2004

(54) User-controlled sale and delivery tracking system

(76) Inventor: Christopher J. Grubb, St. Joseph, MO (US)

Correspondence Address: Shipley, Lawson & Jacob LLC, Suite 101, 324 E. 11th St., Kansas City, MO, 64106, US

(21) Appl. No.: 10/824,295

(22) Filed: Apr. 14, 2004

Related U.S. Application Data
(60) Provisional application No. 60/462,743, filed on Apr. 15, 2003.

(51) Int. Cl. G06F 7/00; H04K 1/00; H04L 9/00

(52) U.S. Cl. 705/80

(57) ABSTRACT

A computer-network-based system (10) for negotiating the sale and tracking the delivery of an item. The system (10) includes a front-end application (12) and a database (14) communicatively coupled to the application (12). The front-end application (12) includes a user input module (30) for receiving input from a user, a sales negotiation module (38) for achieving a sale price, and a generator module (40) for generating a readable medium, wherein the readable medium is provided to the user within a period and includes computer-readable codes matched to the user input. The application (12) includes a receiver input module (44) for producing a delivery indicator, and a payment request module (46) for initiating a user selected action upon production of the indicator. The application (12) further includes a query execution module (42), an agent module (34), and an administration module (36) for accessing and modifying the database (14).

### CROSS REFERENCE TO RELATED APPLICATIONS

This application claims the benefit of provisional application Ser. No. 60/462,743 filed Apr. 15, 2003 entitled “Reliable buy back program (RBB program)”, the teachings of which are incorporated herein by reference.

### IDENTIFICATION OF COPYRIGHT PURSUANT TO 37 CFR 1.71(D) AND (E)

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates generally to computer-network-based systems. More specifically, the present invention relates to a computer-network-based system for negotiating the sale of an item and generating and tracking a readable identification medium.

2. Discussion of Prior Art

Conventional computer-network-based systems have been developed for facilitating the return of products in commercial industry. Companies have sought to provide value added services to consumers by enabling the consumer to return products for various reasons. In exchange for the returned product, the consumer is often able to obtain a refund or credit towards future transactions. To effect the traceable return of the product, the user is required to generate a readable medium, such as a certified or express mailing label, at a specified third-party location, such as a post office branch or express delivery depository. In some instances, the medium is obtained by the company and mailed to the consumer after a lapse period at least equal to the time necessary for processing and mailing the medium. The consumer can then attach the medium to the product and mail the combination to the company. Once received, the company processes the refund or credit.

These policies, however, are disadvantaged by inefficiency and inconvenience. Return transactions, for example, are often voluntarily or involuntarily dropped by consumers who do not complete the process. These consumers typically fail to obtain the medium by not traveling to the specified location or by becoming distracted during the lapse period after initiating the transaction and neglecting the medium once received. Where the cost of third-party delivery, which is charged to the consumer, is greater than the refund or credit, the consumer may elect not to complete the transaction. In these situations, under traditional cost-factor analysis, the company must increase the refund or credit, and thereby reduce profit margin, to complete the transaction.

Finally, conventional computer-network-based systems implemented for these purposes are typically controlled by company personnel during the transaction. These systems adversely impact consumer confidence by requiring the consumer to trust the proper application of the system to his or her transaction. In particular, the consumer must trust company personnel to properly read the medium, match his or her returned product with his or her account and initiate payment. All of these factors are risks to be considered by the consumer when undertaking a cost-factor analysis of whether to return the product.

### SUMMARY OF THE INVENTION

Responsive to these and other problems caused by conventional return systems, the present invention concerns an improved system, method and article of manufacture for negotiating the sale and tracking the delivery of an item by a user. Among other things, the invention provided hereof, is useful for reducing the lapse period between a sale and shipment, and increasing user confidence.

A first aspect of the present invention concerns a user-controlled system for negotiating the sale and tracking the delivery of an item across a network. The system includes a user input module configured to operate on a first computer station located at a first location and communicate with a database. The user input module is further configured to receive an input from a user. The system also includes a sale negotiation module configured to communicate with the database and achieve a sale price for the item. The system also includes a generator module configured to request and provide a readable medium to the user at the first location and to communicate with the database. The medium includes computer-readable codes matched to the input.

A second aspect of the present invention concerns a user-controlled method of negotiating the sale and tracking delivery of an item across a network. The method includes the steps of receiving user identification input from a user at a first location, achieving a sale price for the item at the first location, and requesting and providing a readable medium at the first location. The medium includes computer-readable codes matched to the input and is provided to the user within a period of time from the request. The method further includes the steps of attaching the medium to the item and delivering the medium and item to a second location remotely located from the first location, and reading the medium and producing a delivery indicator at the second location.

A third aspect of the present invention concerns an article of manufacture comprising program storage medium readable by a processor and embodying one or more instructions executable by the processor to perform a method of negotiating the sale and tracking the delivery of an item. The method includes the steps of receiving user identification input from a user, achieving a sale price for the item, and requesting and providing a readable medium. The medium includes computer-readable code matched to the input and is provided to the user within a period of time from the request. The method further includes the steps of producing a delivery indicator, and storing the sale price, input, medium and indicator in a record on a database.

Other aspects and advantages of the present invention will be apparent from the following detailed description of a preferred embodiment and the accompanying drawing figures.

### BRIEF DESCRIPTION OF THE DRAWING FIGURES

A preferred embodiment of the invention is described in detail below with reference to the attached drawing figures, wherein:

FIG. 1 is a schematic block diagram of a computer-network-based system suitable for negotiating the sale and tracking the delivery of an item and having three or more stations in accordance with the present invention;

FIG. 2 is a schematic block diagram of a computer-network-based system suitable for negotiating the sale and tracking the delivery of an item and having two or more stations in accordance with the present invention;

FIG. 3 is a schematic flow chart of a general method of generating and tracking a readable identification medium using the system shown in FIGS. 1 and 2; and

FIG. 4 is a schematic flow chart of the authorization module, agent module, and administration module of the system shown in FIGS. 1 and 2, particularly illustrating the user interfaces.

### DETAILED DESCRIPTION OF A PREFERRED EMBODIMENT

The following detailed description of the embodiments of the system and methods of the present invention, as represented in the Figures, is not intended to limit the scope of the invention, as claimed, but is merely representative of presently preferred embodiments of the invention. It will be readily understood that the components of the present invention may be arranged and designed in a wide variety of different arrangements.

The Figures include schematic block diagrams and flow chart diagrams which illustrate in more detail a preferred embodiment of the present invention. The illustrated embodiment includes certain modules for performing various functions of the present invention on a computer-network-based system. As such, the represented modules include therein executable and operational data for operation within a computer.

I. General System Overview:

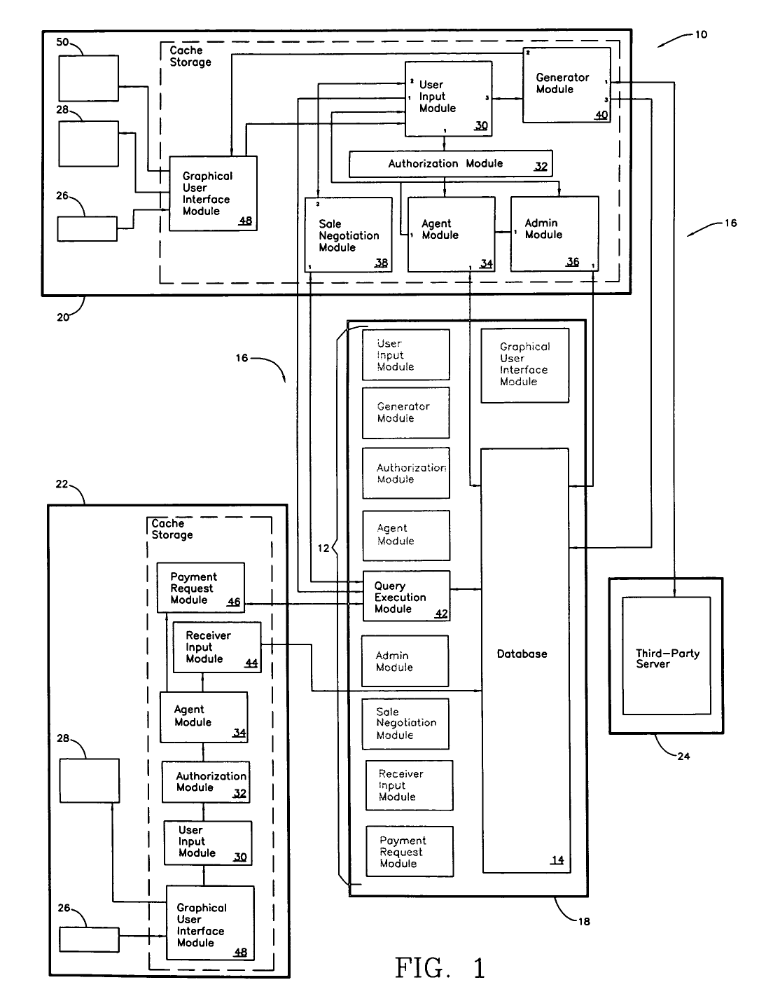

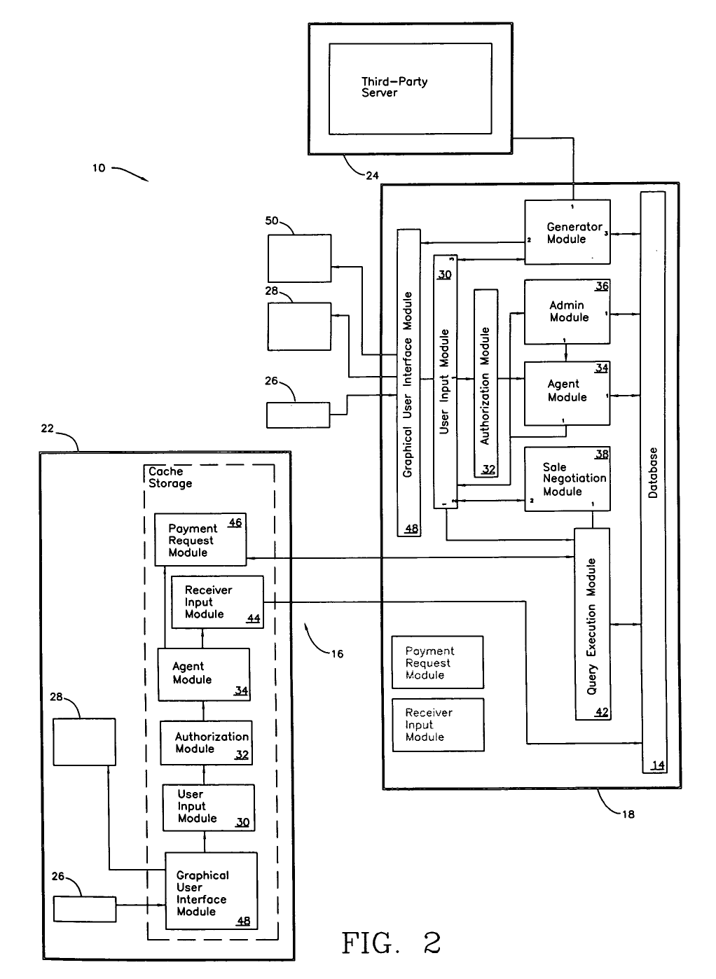

As best shown in FIGS. 1 and 2, the present invention generally concerns a computer-network-based system 10 for negotiating the sale of an item (not shown) and generating and tracking a readable identification medium (also not shown). The system comprises a front-end application 12 and a database 14. The application 12 interacts with the user via multiple modules, which are preferably cached on the user's local computer station. As will be further discussed herein, when database access is required, a Structured Query Language (SQL) request is sent to the database 14 which services the request via a network 16. This allows most of the processing to be done locally, but provides for a central data store that may be shared by many computer stations.

In the illustrated embodiment shown in FIG. 1, the system 10 includes first, second and third computer-stations 18, 20, 22 that are communicatively coupled together. The first station 18 functions as a database server, and the second and third stations 20,22 function as work-stations communicating with the server 18. A second server and forth computer-station 24 is shown communicatively coupled to the first station 18. The following detailed description of a preferred embodiment of the present invention is described with respect to the first station 18 being located at a first location, a user (not shown) and the second station 20 being located at a second location, a receiver (also not shown) and the third station 22 being located at a third location, and the fourth station 24 being located at a fourth location, wherein all locations are remotely located from each other. However, it is well within the purview of the invention for the network 16 to connect a plurality of computer work-stations at different locations far greater than four. As shown in FIG. 2, it is also within the purview of the invention to reduce the number of stations on the network 16 by merging the server 18 with one of the other stations 20,22,24.

II. System Requirements:

Computer stations 18-24, as is commonly known in the art, each preferably include a processor (not shown), i.e. CPU, and one or more memory devices (also not shown) having thereon modules of program code for execution by the processor. The memory devices typically include a non-volatile storage device, i.e. a hard disk drive or CD-ROM drive, read-only memory (ROM), and random access volatile memory (RAM). Preferably, work-station class computer stations 20,22 operate under a suitable operating system, such as System 7.x, MAC OS/9.0, WINDOWS NT, and the like. The first computer-station 18 is preferably a server-class computer, such as an IBM zSeries 900 model mainframe computer operating under a suitable multi-user operating system, such as Red Hat LINUX, SCO UNIX, Free BSD UNIX, Sun Solaris, and the like.

The computer-stations 18-24 include at least one input device 26, such as a mouse, keyboard or scanner, for receiving inputs from the user or receiver. At least one output device 28, such as a monitor or printer, communicates with the processor to produce an output. More preferably, both a monitor and a printer is provided at the first computer-station 18. A network port (not shown), such as a network interface card, may be provided for connecting to outside devices through the network. Finally, a system bus interconnects the processor, the memory devices, the input device 26, the output device 28, the network card, and one or more additional ports.

The computer network 16 may be any network operable to transmit data signals, and may include radio frequencies, cable, fiber optic or otherwise conventional means. The network 16 may comprise a wide area network (WAN), a local area network (LAN), or an interconnected system of networks, such as the World Wide Web network, i.e. Internet. Different communication protocols, e.g., ISO-IP, IPX, TCP/IP, may be used on the network 16, but in the case of the Internet, a single, layered communications protocol (TCP/IP) generally enables communications between the differing networks and stations.

Finally, the system 10 may include personal computers, telephones, personal management devices (“PDA”) or any other device configured to perform the functions herein described.

III. System Application and Program Code:

Executable and operational data are permanently stored within the system 10 on the first computer-station 18 in accordance with the present invention. Any type of computer executable code that can be stored within a memory device and transmitted as electronic signals over a system bus or network can be utilized. More preferably, however, the executable code of the present invention is written in a computer programming language selected from MySQL.RTM, HTML 3.0.RTM, Java 2 Ver. 1.4 SDK.RTM, JavaScript.RTM, PHP: Hypertext Processor 4.RTM, and the like. Most preferably, the executable code of the present invention is written utilizing the PHP programming language. It is appreciated by those skilled in the art, however, that transmitted code back to requesting work-stations are preferably written in the universally recognized HTML language, so that a plurality of computer types can be utilized within the system 10. One example of suitable code for implementing the functions of the present invention is registered under United States Copyright Certification No. ______, entitled ______, and incorporated by reference herein.

As best shown in FIG. 1, the first station 18 preferably stores the database 14, as well as the front end application 12. The application 12 preferably comprises of ten modules, wherein an identified module of executable code may comprise one or more physical or logical blocks of computer instructions and may be organized as an object, procedure, or function. It is appreciated by those skilled in the relevant art, however, that equivalent functionality can be achieved by fewer or more modules.

In the illustrated embodiment, the preferred database 14 comprises a Relational Database Management System (RDBMS). One example of a suitable RDBMS is the IBM DB2 Universal Database.RTM. Of course, other types of database systems could be used as well, such as hierarchical database systems, one example of which is IBM's IMS.RTM. It is certainly within the purview of the invention, however, for a combination of database systems to be utilized. The front end application 12 and database 14 are linked via an interface (not shown), such as DB2 Connect.RTM., also available from IBM.

The front-end application 12 includes principal components necessary for the proper function of the system 10, and more particularly a user input module 30, an authorization module 32, an agent module 34, an administration module 36, a sale negotiation module 38, a medium generator module 40, a query execution module 42, a receiver module 44, and a payment request module 46, which will be described in more detail herein. The components are preferably coupled to a graphical user interface (“GUI”) module 48 that allows the user to interact with the components more efficiently.

As is commonly known in the art, the GUI design is created by a graphical design program. More preferably, the GUI design is created by a program selected from the group consisting of Adobe Photoshop.RTM, Adobe Illustrator CS.RTM, and Macromedia Flash MX.RTM. As shown in FIG. 1, the GUI is primarily configured to be displayed on the output device 28 of the second and third stations 20,22.

In the illustrated embodiment, the system 10 is accessed by the user through the second station 20. The preferred second station 20 has sufficient cache memory storage for locally storing at least a copy of the GUI module, and more preferably also a copy of the user input module 30, authorization module 32, and either the sale negotiation 34, agent module 36, administrative module 38, or a combination of the three, depending upon the authority of the user and the desired functionality. Most preferably, the entire front-end application 12 can be locally stored in cache storage on the second and third stations 20,22.

As will be further discussed with respect to methodology, the user initiates a transaction by invoking the GUI, user input, and authorization modules 48,30,32. The authorization module 32 provides a gateway to the remaining modules. The user input module interrelates with the authorization module to match a particular user identification input with each of the modules which that user is authorized to access. To perform this inquiry, the authorization module 32 cooperates with the query execution module 42 to send an SQL request to at least one authorization table stored on the database 14.

In the illustrative embodiment, three types of users are authorized to access at least a portion of the system 10. First, all users with a recognized account number or PTN (cellular) Number (“possessors”) can access the sale negotiation module 38, the generator module 40, and the query execution module 42. Second, authorized agents can access the same modules as a possessor plus the agent module 34, wherein the agent module 34 primarily includes additional code for assisting a possessor in obtaining a copy of the readable medium. For example, a possessor who does not have access to a work-station on the network 16, but who does have access to a facsimile device, may provide user input, achieve a sale price and generate a readable medium via an agent. The agent can subsequently fax a copy of the medium to the possessor at his or her location.

As shown in FIG. 1, the agent module 34 is configured to operate on the second and third stations 20,22 and cooperate with the GUI module 48. It should be noted, however, that the contemplated agency relationship is preferably with the receiver, and as such, the GUI module 48 when cooperating with the agent module 34 need not include instructional and marketing indicia directed towards possessors. To enable customization, the agent module 34 is further configured to access and modify a portion of the database 14. More particularly, the agent module 34 is configured to enable the agent to choose between an outgoing contact/new quote interface, wherein the agent initiates contact with a possessor, an incoming contact/edit quote interface, wherein the agent is contacted by a possessor, a reporting interface, wherein the agent can compile reports, such as an outstanding orders report, a delivered items report, or a payment received report, a reminder interface, wherein the agent contacts possessors with outstanding orders, a receiving interface/module described in more detail herein, and a utilities interface, wherein the agent is able to modify a portion of the database 14 excluding the authorization and threshold price tables, which will be further described herein.

Authorized administrators can access the same modules as an agent, plus the administrative module 36. More particularly, administrators are able to access additional interfaces, such as an administrative reporting interface, wherein reports analyzing the performance of the system are produced, and a batch process interface, which is configured to provide context based help. The utilities interface in the administration module 36 is configured to access and modify the entire database 14, including the authorization and threshold price tables. As shown in FIG. 1, the administrative module 36 is configured to operate on the second or third stations 20,22 similarly to the agent module 34. Thus, both the agent and administration modules 34,36 can be accessed by the user either to modify the database 14 or to assist a possessor in using the system 10.

More particularly, if there is a match between the user identification input and one of the listed modules stored in the authorization tables, then the database server will access that module and transmit it back to the requesting station in HTML. If there is no match found, the user is eventually returned to the user input module and is not allowed to complete the process. Once the user is recognized as a possessor, the sale negotiation module 38 is accessed by and preferably cached on the second computer 20. In the illustrated embodiment, the user input module 30 is further configured to receive a model identification input matching the item to be shipped. More preferably, a list box executable script entrained in the GUI module 48 and including all of the available item models for which the sales negotiation module 38 is applicable facilitates the receipt of the model identification input.

Based on the selected item, the sales negotiation module 38 is further configured to achieve a sale price for the item. More preferably, the sale negotiation module 38 and input module 30 are cooperatively configured to initially receive an asking price from the user. In this regard, the negotiation module 38 is further configured to compare the asking price to a predetermined threshold price for the item. To perform this task, the sale negotiation module 38 communicates with at least one threshold price table (not shown) on the database 14, and more particularly, cooperates with the query execution module 42 to send an SQL ID to the database 14 to match the selected item with the proper threshold price. The threshold price table is preferably updated on a periodic basis. More preferably, the threshold price table is updated at least once a week and is equal to the average asking price for that item during the most recently ending week. The sale negotiation module 38 is further configured to set the sale price equal to the lesser of the asking price and the matching threshold price from the database 14.

The user input module 30 is further configured to receive additional user input, such as the number of items to be shipped, the complete name, phone number, and return address of the user, and the destination address.

The medium generator module 40 is configured to cause the generation of a readable medium, wherein the term “medium” shall mean the actual image file of the medium, an electronic or tangible copy of the image file, or a direct reference to the image file. The preferred medium includes computer-readable codes, i.e. bar, circle or dot codes, that can be scanned using a conventional scanning device. It is appreciated by those in the art, that providing a scannably readable medium increases efficiency and reduces human error. The generator module 40 is further configured to cooperatively provide the medium to the user within a period from the request, wherein the term “provide” as used in this context shall mean to make the medium accessible to the user, i.e. deliver the medium to a printable display, an electronic email address, or a facsimile device, accessible by the user. More preferably, the medium is provided to the user within a period not greater than five hours, and most preferably, within a period not greater than five minutes.

In the illustrated embodiment, the generator module 40 causes an image of a readable identification medium to be displayed on the monitor 28 within the second station 20. To accomplish this task, the generator module 40 communicates with the second server 24, and is configured to convert a portion of the user input into data that is recognizable by the second server 24. The second server 24 converts the data into a bar-coded mailing label and dynamically produces an image file of the same. Once displayed, the GUI module 48 and an output printer device 50 coupled to the second station are preferably configured to cooperatively print the label on adhesive-back paper. However, it is within the purview of the invention for the generator module 40 to cooperatively produce other forms of readable medium, such as magnetic labels, electronic chips, etc., that can be attached to the item.

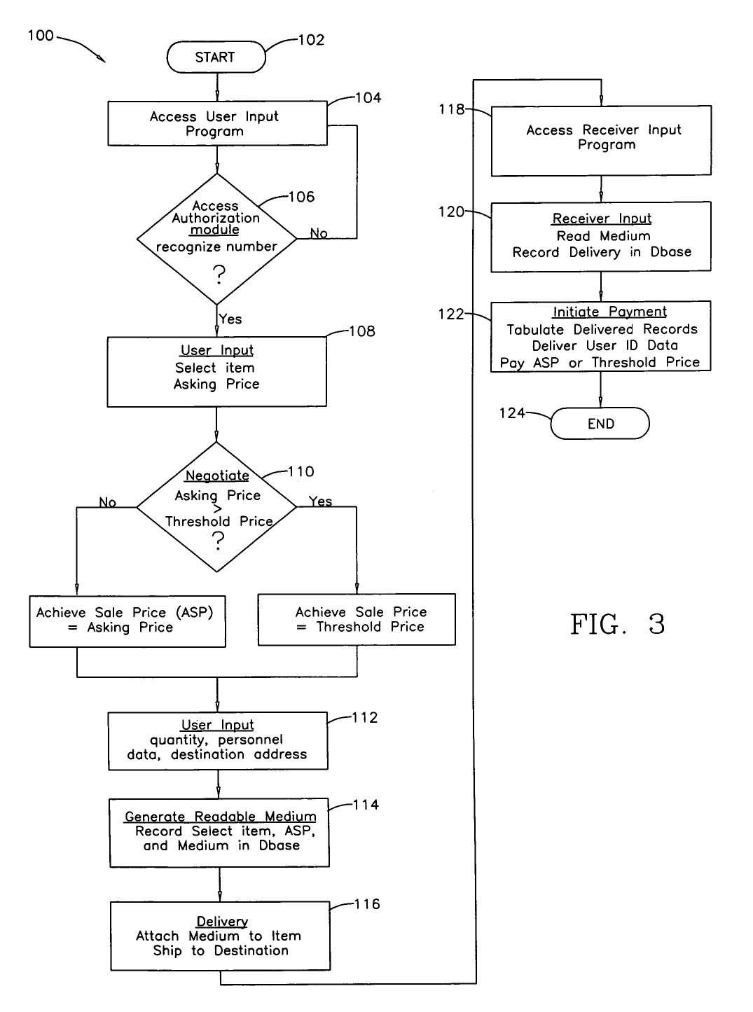

So as to increase user and receiver confidence, the second server 24 is preferably owned and operated by a third-party delivery or mailing service that is independent to both the user and receiver, such as the U.S. Postal Service, Federal Express, or the United Parcel Service. As shown in FIG. 1, the second server 24 is bi-directionally coupled to the second station 20 to receive the recognizable input and send the image of the generated medium. Once the generated medium has been attached to the item, the medium and item combination can be shipped to the third station 22, as shown in FIG. 3.

At the third station 22, the receiver module 44, accessible through the agent module 34, is configured to receive delivery input from an input device 26, convert the delivery input into a delivery indicator, and store the delivery indicator in the database 14. More preferably, the delivery indicator is interrelated with matching user input stored on the database. Most preferably, the delivery indicator and matching user input are stored within a retrievable user record on the database 14. Finally, the delivery indicator may be a simple text message, such as “DELIVERED ON XX/XX/XXXX,” or a check box.

In the illustrated embodiment, the medium is preferably read using a bar code scanner input device 26, which is communicatively coupled to the second computer station 22. Conventionally, the scanner is passed across the encoded data to access the identifying information of the attached item. The scanner and receiver module 44 are cooperatively configured to communicate via electrical wiring, infrared technology, RF transmission or otherwise conventional means. Examples of suitable RF scanners are disclosed in U.S. Pat. Nos. 4,970,379 to Danstrom, U.S. Pat. No. 4,882,476 to White, and U.S. Pat. No. 4,894,523 to Chadima. The scanner preferably includes a bar code scanning interface (not shown), a manual input bypass keyboard (not shown), and a display (also not shown). The keyboard and scanning interface provide alternative forms of data entry, depending upon whether the encoded data, i.e. the bar codes, can be read. In this regard, it is necessary for the readable medium to include two forms of data, encoded data and visual data preferably written in the language of the receiver. If direct connection to the third station 22 is not provided, the receiver can utilize the display to view the data and produce the delivery indicator manually.

Alternatively, tracking may be performed by the third-party delivery service, so as to increase user confidence in the system. In this arrangement, the agent module 34 may be further configured to periodically communicate with an FTP file link to obtain delivery data preferably stored on the third-party server 24. The receiver module 44 and agent module 34 are further configured to cooperatively convert the obtained delivery data into the delivery indicators to be stored in the database 14 or to compare the obtained delivery data to existing delivery indicators stored in the database 14.

The agent module 34 is further configured to access the payment request module 46 where the third station 22 is also the final destination of the item. That is to say, the item and medium combination can be tracked in transit, such that the produced delivery indicator at a non-final destination station is actually a milestone indicator. In the illustrated embodiment, however, the third station 22 is the final destination and the payment request module 46 is preferably stored in cache storage at the third station 22.

The payment request module 46 includes a report creator configured to produce a report of delivered items, i.e. records having delivery indicators present, and submitting this report to the receiver for payment. More preferably, for faster and more efficient handling, the payment request module also includes an invoice creator for merging the report data into separate invoices per user. In the illustrated embodiment, the payment request module 46 is also configured to perform other user selected actions, such as making a charitable donation on behalf of the user, or applying a credit to an existing account, upon the production of the delivery indicator.

Finally, the query execution module 42, in addition to the cooperative functions provided above, can be accessed by the user, agent or administrator to obtain information from the database 14. For example, the query execution module can be utilized by the user to access at least a portion of the user record. To perform this task, the query execution module 42 includes an SQL interface for communicating with the database 14. The SQL interface allows users to request, manipulate and retrieve information stored in the database by performing relational operations on the records located in the database, either interactively, in batch files, or embedded in host languages. The query execution module 42 is preferably configured to locally store portions of query results in cache storage. More particularly, when the query execution module is executed to retrieve a record from the database, that record is stored on the work station, so that future access to the same data will be retrieved from cache storage. As is commonly known in the art, various methods may be used to manage data in cache storage, including maintaining a first-in-first-out (FIFO) system in which a constant volume of the most recent data is kept in storage.

As shown in FIG. 2, the system 10 can also be accessed by the user at the first station 18, wherein the entire front-end application 12 and the database 14 are stored; thereby eliminating the need for the second station 20. In this arrangement, the first station 18 can be configured to communicate with other similar stations across the network 16, such that data contained on one database is accessible by the other. More preferably, these stations can be geographically located, so as to facilitate the actual mailing of items. For example, a plurality of stations, similar to the first station 18 and having processors, memory and output configurations exclusively dedicated to the system 10 can be placed at different public or quasi-public locations. Each station could further provide a drop box and supply bin for obtaining packaging material.

IV. System Methodology:

FIG. 3 illustrates a method 100 of using the system 10 as described in the illustrated embodiment to negotiate the sale and track the delivery of the item. The method 100 starts at a step 102 in which the program is provided on the first station 18. This may comprise writing and producing the program, or may simply comprise buying, licensing or otherwise procuring a copy of the program. At a step 104, the application 12 is called by the user using an operating system on the second station 20 and loaded in cache storage. At this time, the GUI and user input modules are accessed by the user, who uses an input device 26 to enter his or her user identification input.

At a step 106, the authorization module 32 compares the user identification input to the authorization tables on the database 14 to determine if the user is a possessor of a valid account or PTN number. If so, the user is allowed to complete the transaction. At a step 108, additional user input is entered by the user including the model identification of the item, and an asking price. Next, in step 110, the sale negotiation module 38 compares the asking price to a matching threshold price to achieve the sale price. At a step 112, if the sale price is acceptable the user enters more additional input, including quantity, his or her name, phone number, email and return addresses, and the destination address. At a step 114, the generator module 40 communicates with a third-party service to generate a bar-code mailing label. At this time, user input and the medium are stored in a user record on the database. Finally, at a step 116, the user attaches the medium to the item and ships the combination item and medium to the third location.

After the combination is delivered to the third station 22 and at a step 118, the receiver accesses the receiver input module 44. At a step 120, the receiver reads the medium via the input device 26 and uses the receiver input module 44 to produce a delivery indicator in the user record. After the delivery indicator is produced and at a step 122, the payment request module 46 is utilized to create a report of the delivered items to the receiver for processing payment. When the payment request module completes its report, the method 100 ends at step 124. At any point during the method between steps 116 and 124, the user can utilize the query execution module 42 to access his or her user record and determine if a delivery indicator has been entered.

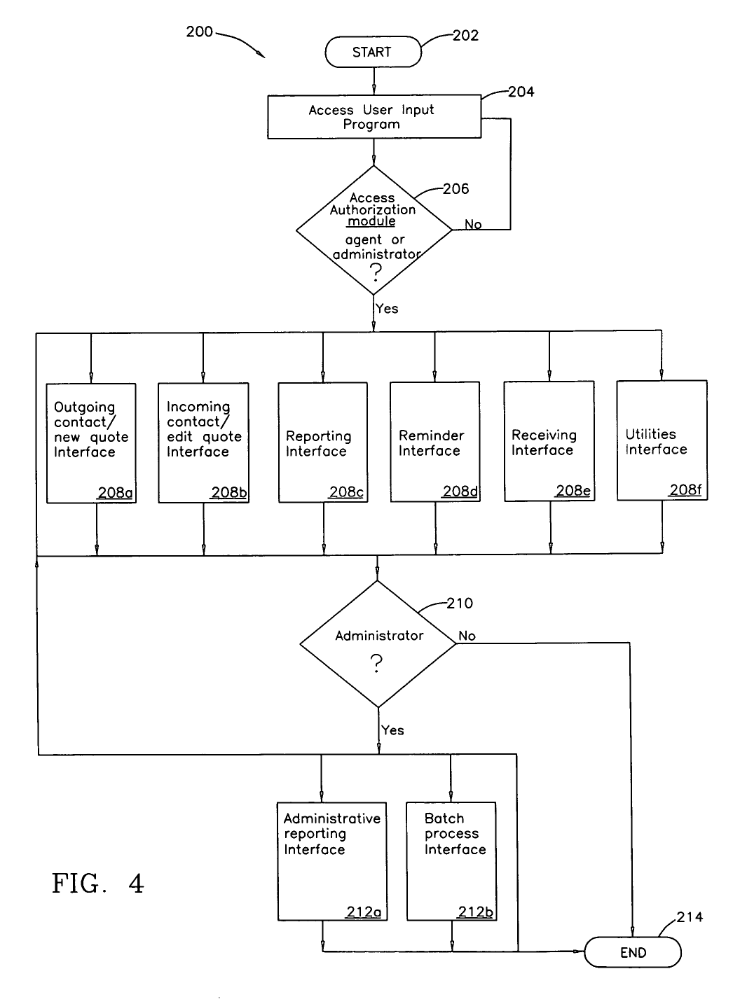

FIG. 4 illustrates a method 200 of using the system 10 as an agent or administrator. The method 200 starts at a step 202 in which the program is provided and called by a user as in method 100. At a step 204, the user inputs user identification input and accesses the authorization module 32. At a step 206, the authorization module 32 compares the user identification input to the authorization tables on the database 14 to determine whether the user is agent or administrator.

If the user is recognized as an agent or administrator, the method 200 proceeds to one of a plurality of steps 208a-f. There the user is presented with a choice of interfaces, including an outgoing contact/new quote interface 208a, an incoming contact/edit quote interface 208b, a reporting interface 208c, a reminder interface 208d, a receiving interface 208e, and a utilities interface 208f. Steps 208a-f are preferably non-sequential and non-exclusive. That is to say, the user can complete all or a portion of the steps 208a-f in any order before exiting the system 10. For example, where contacted by a possessor the user can select the incoming contact/edit quote interface 208b, and begin the sale negotiation and generation method 100. Once the medium is generated and provided to the user, the user can access the utilities interface 208f to check that a proper record has been stored. Once the user is complete with steps 208a-f and at a step 210, the user, if an agent, must log off and skip to step 214 where the method 200 ends.

At step 210, if the user is recognized as an administrator, the user is allowed to proceed to one of a plurality of steps 208a-f and 212a,b. Thus, as an administrator, the user is able to select from additional interfaces, including an administrative reporting interface 212a, and a batch process interface 212b.

Obvious modifications to the exemplary embodiments and methods of operation, as set forth herein, could be readily made by those skilled in the art without departing from the spirit of the present invention. The inventor hereby states his intent to rely on the Doctrine of Equivalents to determine and assess the reasonably fair scope of the present invention as pertains to any system not materially departing from but outside the literal scope of the invention as set forth in the following claims.

What is claimed is:

1. A user-controlled system for negotiating the sale and tracking the delivery of an item across a network, said system comprising:
a user input module configured to operate on a first computer station located at a first location and communicate with a database,
said user input module being further configured to receive an input from a user;
a sale negotiation module configured to communicate with the database, and achieve a sale price for the item; and
a generator module configured to request and provide a readable medium to the user at the first location and to communicate with the database,
said medium including computer-readable codes matched to the input.

2. The system as claimed in claim 1; and
a receiver input module accessible at a second location and configured to communicate with the database,
said receiver input module being further configured to produce a delivery indicator.

3. The system as claimed in claim 2,
said receiver input module being configured to operate on a second computer station at the second location, and to receive input from a scanning device.

4. The system as claimed in claim 2,
said input and indicator being stored in a record on the database; and
a query execution module configured to operate on the first computer station and communicate with the database,
said query execution module being further configured to request and retrieve at least a portion of the record.

5. The system as claimed in claim 4,
said medium being stored in the record.

6. The system as claimed in claim 2; and
a payment request module communicating with the database, and configured to initiate a user selected action upon production of the delivery indicator.

7. The system as claimed in claim 6,
said action being selected from the group consisting essentially of paying the sale price to the user, making a charitable contribution on behalf of the user, and crediting an existing account.

8. The system as claimed in claim 1,
said database being stored on a second computer station at a second location, wherein the second station communicates with the first station across the network.

9. The system as claimed in claim 1,
said sale negotiation module being configured to receive an asking price from the user.

10. The system as claimed in claim 1,
said network comprising a plurality of interconnected networks hosting a plurality of computer work-stations.

11. The system as claimed in claim 1; and
a graphical user interface module configured to communicate with the user input module, sale negotiation module, and generator module,
said graphical user interface module being further configured to be displayed on an output device connected to the first computer station.

12. The system as claimed in claim 11,
said graphical user interface module including an SQL query text editor configured to receive a query from the user.

13. The system as claimed in claim 1,
said medium being provided to the user within five hours from the request.

14. The system as claimed in claim 13,
said medium being provided to the user within five minutes from the request.

15. The system as claimed in claim 1; and
an administration module configured to communicate with and modify at least a portion of the database.

16. A user-controlled method of negotiating the sale and tracking delivery of an item across a network, said method comprising the steps of:
(a) receiving user identification input from a user at a first location;
(b) achieving a sale price for the item at the first location;
(c) requesting and providing a readable medium at the first location, wherein the medium is provided to the user within a period of time from the request, and includes computer-readable codes matched to the input;
(d) attaching the medium to the item and delivering the medium and item to a second location remotely located from the first location; and
(e) reading the medium and producing a delivery indicator at the second location.

17. The method as claimed in claim 16; and
(f) initiating a user selected action upon production of the delivery indicator at the second location.

18. The method as claimed in claim 17,
said action being selected from the group consisting essentially of paying the sale price to the user, making a charitable contribution on behalf of the user, and crediting an existing account.

19. The method as claimed in claim 16,
steps (a),(b),(c) and (e) including the steps of storing the price, input, medium and indicator in a record on a database.

20. The method as claimed in claim 19; and
(f) accessing at least a portion of said record at the first location.

21. The method as claimed in claim 19, wherein said database is stored at a third location.

22. The method as claimed in claim 16,
step (b) including the steps of receiving an asking price from the user.

23. The method as claimed in claim 16,
steps (b) and (c) including the steps of achieving the sale price and providing the medium at a first computer station at the first location; and
step (e) including the steps of producing the indicator at a second computer station located at the second location, wherein the first and second computer stations communicate over the network.

24. The method as claimed in claim 23; and
(f) providing a graphical user interface configured to operate on the first and second computer stations.

25. The method as claimed in claim 16,
step (c) including the steps of providing the medium to the user within five hours from the request.

26. The method as claimed in claim 25,
step (c) further including the steps of providing the medium to the user within five minutes from the request.

27. An article of manufacture comprising program storage medium readable by a processor and embodying one or more instructions executable by the processor to perform a method of negotiating the sale and tracking the delivery of an item, the method comprising:
receiving user identification input from a user;
achieving a sale price for the item;
requesting and providing a readable medium, wherein the medium is provided to the user within a period from the request, and includes computer-readable codes matched to the input;
producing a delivery indicator; and
storing the input, sale price, medium, and indicator in a record on a database.

28. The article of manufacture as claimed in claim 27, wherein the method further comprises initiating a requested action by the user upon production of the delivery indicator.

29. The article of manufacture as claimed in claim 28, wherein said action is selected from the group consisting essentially of paying the sale price to the user, making a charitable contribution on behalf of the user, and crediting an existing account.

30. The article of manufacture as claimed in claim 27, wherein the method further comprises accessing a user-selected portion of the database at the first location.

31. The article of manufacture as claimed in claim 30, wherein the method further comprises modifying the user-selected portion.

32. The article of manufacture as claimed in claim 27, wherein the method further comprises receiving an asking price from the user prior to achieving the sale price.

33. The article of manufacture as claimed in claim 27, wherein the method further comprises providing a graphical user interface.

34. The article of manufacture as claimed in claim 27, wherein the period is not greater than five hours.

35. The article of manufacture as claimed in claim 34, wherein the period is not greater than five minutes.
